(19) United States
(12) Patent Application Publication
(10) Pub. No.: US 2013/0009909 A1
(43) Pub. Date: Jan. 10, 2013

(54) Display Device

(75) Inventors: Shunpei Yamazaki, Tokyo (JP); Jun Koyama, Sagamihara (JP)

(73) Assignee: Semiconductor Energy Laboratory Co., Ltd.

(21) Appl. No.: 13/542,110

(22) Filed: Jul. 5, 2012

(30) Foreign Application Priority Data
Jul. 8, 2011 (JP) 2011-152067

(51) Int. Cl. G06F 3/044

(52) U.S. Cl. 345/174

(57) ABSTRACT

A display device with high accuracy in object detection is provided. The display device includes a light-detection touch sensor, a capacitive touch sensor, and an illuminance sensor configured to detect the illuminance of external light. The information about the illuminance detected by the illuminance sensor is used to choose either the light-detection touch sensor or the capacitive touch sensor for imaging. That is, an appropriate touch sensor is chosen from the two kinds of touch sensors. Accordingly, the object detection accuracy can be prevented from decreasing due to the influence of external light.

### BACKGROUND OF THE INVENTION

1. Field of the Invention

The present invention relates to a display device.

2. Description of the Related Art

Display devices in which display on a screen can be operated when a user touches the screen (image input/output devices) have been developed in recent years (see Patent Document 1, for example).

### REFERENCE

[Patent Document 1] Japanese Published Patent Application No. 2010-134454

### SUMMARY OF THE INVENTION

In a display device disclosed in Patent Document 1, an object is detected using a light-detection circuit (light-detection element). However, detection using a light-detection circuit is sensitive to external light. Specifically, it may be difficult to perform the detection when the display device is placed in a very bright or dark environment. In view of this, it is an object of one embodiment of the present invention to provide a display device with high object detection accuracy.

A display device according to one embodiment of the present invention includes an illuminance sensor which detects the illuminance of external light. One feature is to choose between driving a light-detection touch sensor and driving a capacitive touch sensor on the basis of information about the illuminance detected by the illuminance sensor.

Specifically, one embodiment of the present invention is a display device which includes a display including a light-detection touch sensor, a capacitive touch sensor overlapping with the display, an illuminance sensor configured to detect the illuminance of external light, a control unit configured to choose between driving the light-detection touch sensor and driving the capacitive touch sensor on the basis of an output value of the illuminance sensor.

The display device according to one embodiment of the present invention is capable of choosing an appropriate touch sensor from the two kinds of touch sensors. Accordingly, the object detection accuracy can be prevented from decreasing due to the influence of external light.

### BRIEF DESCRIPTION OF THE DRAWINGS

FIGS. 1A and 1B are a perspective view and a cross-sectional view, respectively, illustrating a configuration example of a display device.

FIG. 2 illustrates a configuration example of a display.

FIGS. 3A and 3B illustrate configuration examples of light-detection circuits, and FIGS. 3C and 3D illustrate examples of driving methods thereof.

FIGS. 4A and 4B illustrate configuration examples of display circuits, and FIGS. 4C and 4D illustrate examples of driving methods thereof.

FIGS. 5A and 5B are a schematic plan view and a schematic cross-sectional view, respectively, of a display circuit.

FIGS. 6A and 6B are a schematic plan view and a schematic cross-sectional view, respectively, of a light-detection circuit.

FIGS. 7A and 7B are a schematic cross-sectional view of a display circuit and a schematic cross-sectional view of a light-detection circuit, respectively.

FIG. 8 illustrates a configuration example of a capacitive touch sensor.

FIGS. 9A and 9B illustrate a configuration example of a capacitive touch sensor.

FIG. 10 is a flow chart showing an operation example of a display device.

FIG. 11 illustrates a configuration example of an electronic device.

FIGS. 12A to 12F illustrate specific examples of electronic devices.

FIG. 13 illustrates a structural example of a light-detection circuit.

### DETAILED DESCRIPTION OF THE INVENTION

Embodiments of the present invention will be described in detail below. Note that the present invention is not limited to the following description, and various changes and modifications can be made without departing from the spirit and scope of the present invention. Therefore, the present invention should not be construed as being limited to the following description.

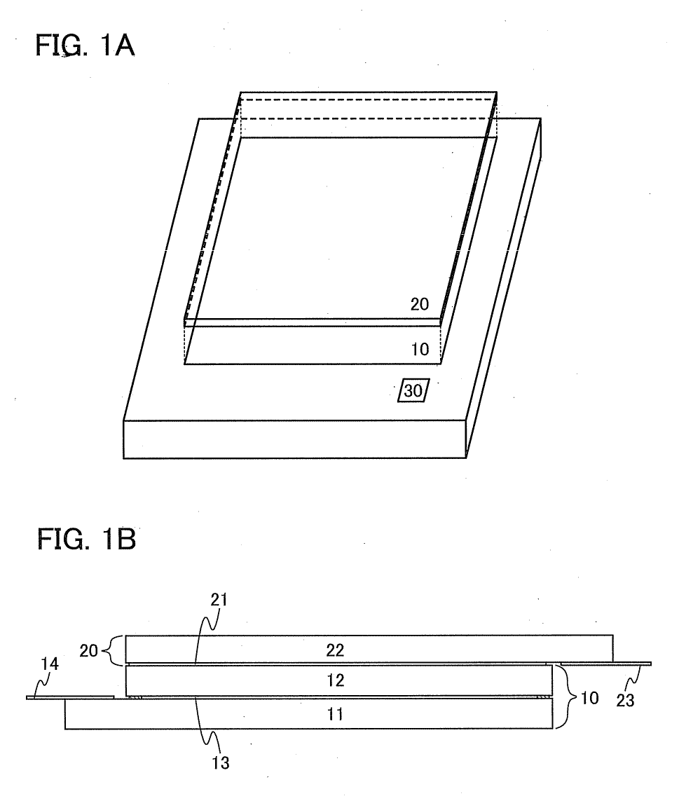

First, a display device according to one embodiment of the present invention will be described with reference to FIGS. 1A and 1B, FIG. 2, FIGS. 3A to 3D, FIGS. 4A to 4D, FIGS. 5A and 5B, FIGS. 6A and 6B, FIGS. 7A and 7B, FIG. 8, FIGS. 9A and 9B, FIG. 10, and FIG. 13.

### <Configuration Example of Display Device>

FIG. 1A illustrates a configuration example of a display device according to one embodiment of the present invention. The display device illustrated in FIG. 1A includes a display 10 which includes a light-detection touch sensor, a capacitive touch sensor 20 which overlaps with the display 10, and an illuminance sensor 30 which detects the illuminance of external light. The display device in FIG. 1A further includes a control unit which chooses between driving the light-detection touch sensor included in the display 10 and driving the capacitive touch sensor 20 on the basis of an output value of the illuminance sensor 30 (information about the illuminance of external light detected by the illuminance sensor 30). Note that an integrated circuit such as a processor, a central processing unit (CPU), or a microcomputer can be used as the control unit.

FIG. 1B is a cross-sectional view illustrating a configuration example of the display 10 and the capacitive touch sensor 20 of the display device illustrated in FIG. 1A.

The display 10 in FIG. 1B includes a pair of substrates 11 and 12 and a liquid crystal 13 between the pair of substrates 11 and 12. The display 10 further includes polarizing plates on outer sides of the substrates 11 and 12 and a backlight on the outer side of the substrate 11 and the polarizing plate (not shown). In other words, the display illustrated in FIG. 1B displays an image by control of the orientation of the liquid crystal. Note that the display 10 in FIG. 1B is one embodiment of the present invention, and a display which displays an image by the utilization of organic electroluminescence can be used as the display 10. In addition, a flexible printed substrate 14 is connected to the display 10.

The capacitive touch sensor 20 in FIG. 1B includes a sensor portion 21 which overlaps with the display 10, and a glass cover 22 which is provided over the display 10 with the sensor portion 21 placed therebetween. In addition, a flexible printed substrate 23 is connected to the capacitive touch sensor 20.

### <Configuration Example of Display>

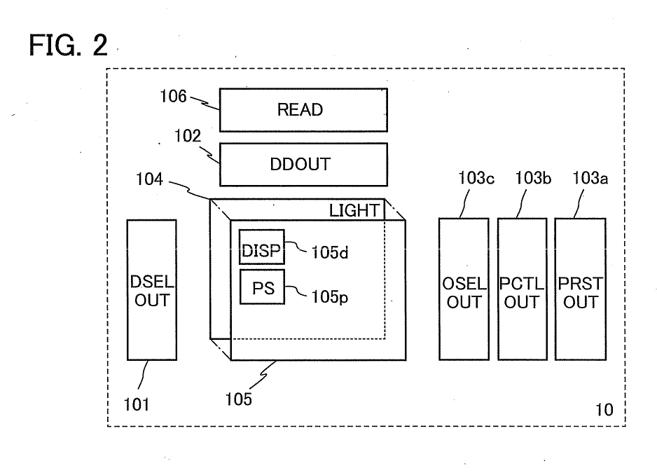

FIG. 2 illustrates a configuration example of the display 10 illustrated in FIGS. 1A and 1B. The display 10 illustrated in FIG. 2 includes a display selection signal output circuit (DSELOUT) 101, a display data signal output circuit (DDOUT) 102, a light-detection reset signal output circuit (PRSTOUT) 103a, a light-detection control signal output circuit (PCTLOUT) 103b, an output selection signal output circuit (OSELOUT) 103c, a light unit (LIGHT) 104, X display circuits (DISP, X is a natural number) 105d, Y light-detection circuits (PS, Y is a natural number) 105p, and a read circuit (READ) 106. Note that the display 10 illustrated in FIG. 2 can display an image using the display circuit 105d and detect an object using the light-detection circuit (which can function as a light-detection touch sensor).

The display selection signal output circuit 101 has a function of outputting a plurality of display selection signals (signals DSEL) which is pulse signals.

The display selection signal output circuit 101 includes a shift register, for example. The display selection signal output circuit 101 can output a display selection signal by output of a pulse signal from the shift register.

An image signal which is an electric signal for displaying an image is input to the display data signal output circuit 102. The display data signal output circuit 102 has a function of generating a display data signal (a signal DD) which is a voltage signal on the basis of the inputted image signal and outputting the generated display data signal.

The display data signal output circuit 102 includes a transistor, for example.

The transistor has two terminals and a current control terminal that controls a current flowing between the two terminals with an applied voltage. Note that without limitation to the transistor, terminals where a current flowing therebetween is controlled are referred to as current terminals. Two current terminals are also referred to as a first current terminal and a second current terminal.

The transistor can be a field-effect transistor, for example. In a field-effect transistor, a first current terminal is one of a source and a drain, a second current terminal is the other of the source and the drain, and a current control terminal is a gate.

Voltage generally refers to a difference between potentials at two points (also referred to as a potential difference). However, values of both a voltage and a potential are sometimes expressed in volts (V) in a circuit diagram or the like, so that it is difficult to distinguish between them. Therefore, in this specification, a potential difference between a potential at one point and a potential to be the reference (also referred to as a reference potential) is used as a voltage at the point unless otherwise specified.

The display data signal output circuit 102 can output data of an image signal as a display data signal when the transistor is on. The transistor can be controlled by input of a control signal which is a pulse signal to the current control terminal. In the case where there is a plurality of display circuits 105d, the display data signal output circuit 102 may output data of an image signal as a plurality of display data signals by selectively turning on or off a plurality of transistors.

The light-detection reset signal output circuit 103a has a function of outputting a light-detection reset signal (a signal PRST) which is a pulse signal.

The light-detection reset signal output circuit 103a includes a shift register, for example. The light-detection reset signal output circuit 103a can output a light-detection reset signal by output of a pulse signal from the shift register.

The light-detection control signal output circuit 103b has a function of outputting a light-detection control signal (a signal PCTL) which is a pulse signal. Note that the light-detection control signal output circuit 103b is not necessarily provided.

The light-detection control signal output circuit 103b includes a shift register, for example. The light-detection control signal output circuit 103b can output a light-detection control signal by output of a pulse signal from the shift register.

The output selection signal output circuit 103c has a function of outputting an output selection signal (a signal OSEL) which is a pulse signal.

The output selection signal output circuit 103c includes a shift register, for example. The output selection signal output circuit 103c can output an output selection signal by output of a pulse signal from the shift register.

The light unit 104 is a light-emitting unit including a light source.

The light unit 104 includes a plurality of light-emitting diodes (LEDs) as light sources.

The light-emitting diodes are light-emitting diodes that emit light with a wavelength in the visible light region (e.g., a region with a wavelength of 360 nm to 830 nm). As the light-emitting diodes, a red light-emitting diode, a green light-emitting diode, and a blue light-emitting diode can be used, for example. Note that the number of light-emitting diodes of each color may be more than one. Alternatively, as the light-emitting diodes, a light-emitting diode of another color (e.g., a white light-emitting diode) may be used in addition to the red, green, and blue light-emitting diodes. In addition, a light-emitting diode that emits light with a wavelength in the infrared light region (e.g., a region with a wavelength longer than 830 nm and shorter than or equal to 1000 nm) may be used.

The display circuit 105d overlaps with the light unit 104. To the display circuit 105d, a display selection signal which is a pulse signal is input, and a display data signal is input in accordance with the inputted display selection signal. The display circuit 105d changes its display state in accordance with data of the inputted display data signal.

The display circuit 105d includes a display selection transistor and a display element, for example.

The display selection transistor has a function of selecting whether data of a display data signal is input to the display element.

The display element changes its display state so as to correspond to data of a display data signal by input of the data of the display data signal with the display selection transistor.

As the display element, a liquid crystal element can be used, for example.

Examples of display methods of the display including a liquid crystal element are a TN (twisted nematic) mode, an IPS (in-plane switching) mode, a STN (super twisted nematic) mode, a VA (vertical alignment) mode, an ASM (axially symmetric aligned micro-cell) mode, an OCB (optically compensated birefringence) mode, an FLC (ferroelectric liquid crystal) mode, an AFLC (antiferroelectric liquid crystal) mode, an MVA (multi-domain vertical alignment) mode, a PVA (patterned vertical alignment) mode, an ASV (advanced super view) mode, and an FFS (fringe field switching) mode.

The light-detection circuit 105p overlaps with the light unit 104. A light-detection reset signal, a light-detection control signal, and an output selection signal are input to the light-detection circuit 105p. Note that when a plurality of light-detection circuits 105p is used, the same light-detection control signal may be input to the plurality of light-detection circuits 105p. Accordingly, a time necessary for all the light-detection circuits to generate optical data can be made shorter, and a period during which light enters the light-detection circuit at the time of generating optical data can be set longer. Note that a method where the same light-detection control signal is input to a plurality of light-detection circuits is called a global shutter method.

The light-detection circuit 105p is reset in accordance with the light-detection reset signal.

In addition, the light-detection circuit 105p has a function of generating data corresponding to the illuminance of incident light (such data is also referred to as optical data) in accordance with the light-detection control signal.

The light-detection circuit 105p also has a function of outputting the generated optical data as an optical data signal in accordance with the output selection signal.

The light-detection circuit 105p includes, for example, a photoelectric conversion element (PCE), a light-detection reset selection transistor, a light-detection control transistor, an amplification transistor, and an output selection transistor. The light-detection circuit 105p further includes a filter for absorbing light with a wavelength in the visible light region.

When light enters the photoelectric conversion element, a current (also referred to as a photocurrent) flows through the photoelectric conversion element in accordance with the illuminance of incident light.

A current control terminal of the light-detection reset selection transistor is supplied with a light-detection reset signal. The light-detection reset selection transistor has a function of selecting whether the voltage of a current control terminal of the amplification transistor is set to a reference value.

A current control terminal of the light-detection control transistor is supplied with a light-detection control signal. The light-detection control transistor has a function of controlling whether the voltage of the current control terminal of the amplification transistor is set to a value corresponding to the photocurrent flowing through the photoelectric conversion element.

A current control terminal of the output selection transistor is supplied with an output selection signal. The output selection transistor has a function of selecting whether optical data is output as an optical data signal from the light-detection circuit 105p.

The light-detection circuit 105p outputs optical data as an optical data signal from a first current terminal or a second current terminal of the amplification transistor.

The display circuit 105d and the light-detection circuit 105p are provided in a pixel portion 105. The pixel portion 105 is a region in which data is displayed and read. A pixel includes at least one display circuit 105d. The pixel may further include at least one light-detection circuit 105p. When there is a plurality of display circuits 105d, the display circuits 105d may be arranged in the row and column directions in the pixel portion 105, for example. Furthermore, when there is a plurality of light-detection circuits 105p, the light-detection circuits 105p may be arranged in the row and column directions in the pixel portion 105, for example.

The read circuit 106 has a function of selecting a light-detection circuit 105p from which optical data is to be read and reading optical data from the selected light-detection circuit 105p.

The read circuit 106 is formed using, for example, a selection circuit. For example, the selection circuit includes a transistor. The selection circuit can read optical data by input of an optical data signal from the light-detection circuit 105p with the transistor, for example.

The display 10 described with reference to. FIG. 2 includes the display circuit, the plurality of light-detection circuits including filters for absorbing light with a wavelength in the visible light region, and the light unit. The light unit includes a plurality of light-emitting diodes that emits light with a wavelength in the visible light region and a light-emitting diode that emits light in the infrared light region. With such a structure, the influence of light in an environment in which the display 10 is placed or light with a wavelength in the visible light region emitted from the light-emitting diode can be reduced when optical data is generated.

### <Configuration Example of Light-Detection Circuit>

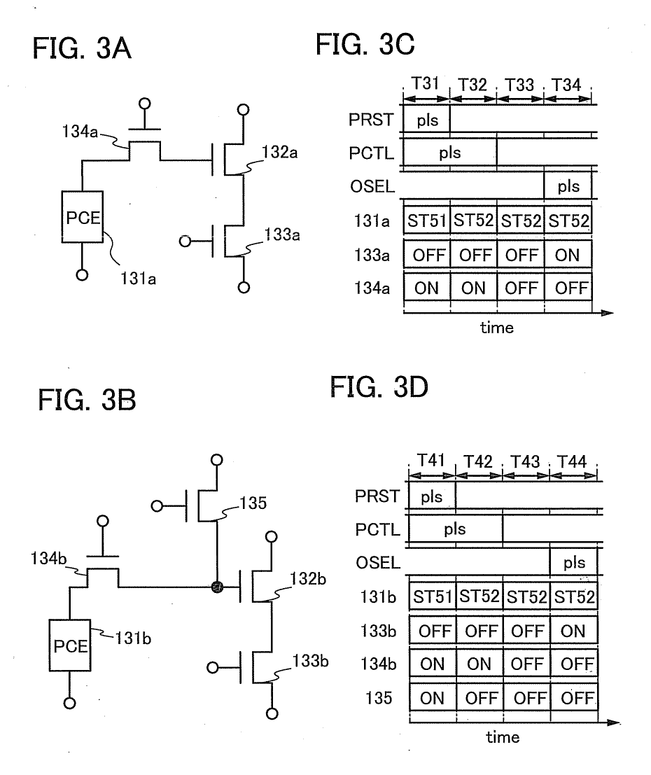

FIGS. 3A and 3B each illustrate a configuration example of the light-detection circuit.

The light-detection circuit illustrated in FIG. 3A includes a photoelectric conversion element 131a, a transistor 132a, a transistor 133a, and a transistor 134a.

In the light-detection circuit in FIG. 3A, the transistors 132a, 133a, and 134a are field-effect transistors.

The photoelectric conversion element 131a has a first current terminal and a second current terminal. A reset signal is input to the first current terminal of the photoelectric conversion element 131a.

One of a source and a drain of the transistor 134a is electrically connected to the second current terminal of the photoelectric conversion element 131a. A gate of the transistor 134a is supplied with a light-detection control signal.

A gate of the transistor 132a is electrically connected to the other of the source and the drain of the transistor 134a.

One of a source and a drain of the transistor 133a is electrically connected to one of a source and a drain of the transistor 132a. A gate of the transistor 133a is supplied with an output selection signal.

Either the other of the source and the drain of the transistor 132a or the other of the source and the drain of the transistor 133a is supplied with a voltage Va.

The light-detection circuit in FIG. 3A outputs optical data from the rest of the other of the source and the drain of the transistor 132a or the other of the source and the drain of the transistor 133a, as an optical data signal.

The light-detection circuit illustrated in FIG. 3B includes a photoelectric conversion element 131b, a transistor 132b, a transistor 133b, a transistor 134b, and a transistor 135.

In the light-detection circuit in FIG. 3B, the transistors 132b, 133b, 134b, and 135 are field-effect transistors.

The photoelectric conversion element 131b has a first current terminal and a second current terminal. A voltage Vb is input to the first current terminal of the photoelectric conversion element 131b.

Note that one of the voltage Va and the voltage Vb is a high power supply voltage Vdd, and the other thereof is a low power supply voltage Vss. The high power supply voltage Vdd is relatively higher than the low power supply voltage Vss. The low power supply voltage Vss is relatively lower than the high power supply voltage Vdd. The values of the voltage Va and the voltage Vb are sometimes interchanged depending on the polarity of the transistors, for example. The difference between the voltage Va and the voltage Vb is a power supply voltage.

One of a source and a drain of the transistor 134b is electrically connected to the second current terminal of the photoelectric conversion element 131b. A gate of the transistor 134b is supplied with a light-detection control signal.

A gate of the transistor 132b is electrically connected to the other of the source and the drain of the transistor 134b.

A light-detection reset signal is input to a gate of the transistor 135. The voltage Va is input to one of a source and a drain of the transistor 135. The other of the source and the drain of the transistor 135 is electrically connected to the other of the source and the drain of the transistor 134b.

An output selection signal is input to a gate of the transistor 133b. One of a source and a drain of the transistor 133b is electrically connected to one of a source and a drain of the transistor 132b.

The voltage Va is input to either the other of the source and the drain of the transistor 132b or the other of the source and the drain of the transistor 133b.

The light-detection circuit in FIG. 3B outputs optical data from the rest of the other of the source and the drain of the transistor 132b or the other of the source and the drain of the transistor 133b, as an optical data signal.

Next, the components of the light-detection circuits illustrated in FIGS. 3A and 3B will be described.

As the photoelectric conversion elements 131a and 131b, photodiodes or phototransistors can be used, for example. When the photoelectric conversion elements 131a and 131b are photodiodes, one of an anode and a cathode of the photodiode corresponds to the first current terminal of the photoelectric conversion element, and the other of the anode and the cathode of the photodiode corresponds to, the second current terminal of the photoelectric conversion element. When the photoelectric conversion elements 131a and 131b are phototransistors, one of a source and a drain of the phototransistor corresponds to the first current terminal of the photoelectric conversion element, and the other of the source and the drain of the phototransistor corresponds to the second current terminal of the photoelectric conversion element.

The transistors 132a and 132b each serve as an amplification transistor.

The transistors 134a and 134b each serve as a light-detection control transistor. Note that the transistor 134a and the transistor 134b are not necessarily provided; in the case where the transistor 134a and the transistor 134b are provided, the gate voltage of the transistor 132a and the transistor 132b can be kept at a desired level for a certain period.

The transistor 135 serves as a light-detection reset selection transistor.

The transistors 133a and 133b each serve as an output selection transistor.

Examples of the transistors 132a, 132b, 133a, 133b, 134a, 134b, and 135 are a transistor including a semiconductor layer containing a semiconductor that belongs to Group 14 of the periodic table (e.g., silicon) and a transistor including an oxide semiconductor layer; a channel is formed in the semiconductor layer or the oxide semiconductor layer. For example, the use of the transistor including an oxide semiconductor layer can suppress variation in the gate voltage due to leakage current of the transistor 132a, 132b, 133a, 133b, 134a, 134b, or 135.

Next, examples of methods for driving the light-detection circuits in FIGS. 3A and 3B will be described.

First, an example of a method for driving the light-detection circuit in FIG. 3A will be described with reference to FIG. 3C. FIG. 3C is a timing chart for explaining the example of the method for driving the light-detection circuit in FIG. 3A and shows the states of the light-detection reset signal, the output selection signal, the photoelectric conversion element 131a, the transistor 133a, and the transistor 134a. Here, the case where the photoelectric conversion element 131a is a photodiode is described as an example.

In the example of the method for driving the light-detection circuit in FIG. 3A, first, a pulse of the light-detection reset signal is input in a period T31. Moreover, a pulse of the light-detection control signal is input in the period T31 and a period T32. Note that in the period T31, the timing of starting input of the pulse of the light-detection reset signal may be earlier than the timing of starting input of the pulse of the light-detection control signal.

At this time, in the period T31, the photoelectric conversion element 131a is set in a state where current flows in the forward direction (also referred to as a state ST51), the transistor 134a is turned on, and the transistor 133a is turned off.

At that time, the gate voltage of the transistor 132a is reset to a given value.

Next, in the period T32 after the input of the pulse of the light-detection reset signal, the photoelectric conversion element 131a is set in a state where voltage is applied in the reverse direction (also referred to as a state ST52), and the transistor 133a remains off.

At this time, a photocurrent flows between the first current terminal and the second current terminal of the photoelectric conversion element 131a in accordance with the illuminance of light entering the photoelectric conversion element 131a. Further, the level of the gate voltage of the transistor 132a varies in accordance with the photocurrent. At this time, the value of the channel resistance between the source and the drain of the transistor 132a is changed.

Then, in a period T33 after the input of the pulse of the light-detection control signal, the transistor 134a is turned off.

At this time, the gate voltage of the transistor 132a is kept at a value corresponding to the photocurrent of the photoelectric conversion element 131a in the period T32. Note that the period T33 is not necessarily provided; however, in the case where there is the period T33, the timing of outputting an optical data signal in the light-detection circuit can be set as appropriate. For example, the timing of outputting an optical data signal can be set as appropriate in a plurality of light-detection circuits.

Next, in a period T34, a pulse of the output selection signal is input.

At this time, the photoelectric conversion element 131a remains in the state ST52, the transistor 133a is turned on, and a current flows through the source and drain of the transistor 132a and the source and drain of the transistor 133a. The current flowing through the source and drain of the transistor 132a and the source and drain of the transistor 133a depends on the level of the gate voltage of the transistor 132a. Therefore, optical data has a value corresponding to the illuminance of light entering the photoelectric conversion element 131a. Further, the light-detection circuit in FIG. 3A outputs an optical data signal from the rest of the other of the source and the drain of the transistor 132a or the other of the source and the drain of the transistor 133a. The above is the example of the method for driving the light-detection circuit in FIG. 3A.

Next, an example of a method for driving the light-detection circuit in FIG. 3B will be described with reference to FIG. 3D. FIG. 3D is a diagram for explaining the example of the method for driving the light-detection circuit in FIG. 3B.

In the example of the method for driving the light-detection circuit in FIG. 3B, first, a pulse of the light-detection reset signal is input in a period T41. In addition, a pulse of the light-detection control signal is input in the period T41 and a period T42. Note that in the period T41, the timing of starting input of the pulse of the light-detection reset signal may be earlier than the timing of starting input of the pulse of the light-detection control signal.

At that time, in the period T41, the photoelectric conversion element 131b is set in the state ST51 and the transistor 134b is turned on, so that the gate voltage of the transistor 132b is reset to a value equivalent to the voltage Va.

Then, in the period T42 after the input of the pulse of the light-detection reset signal, the photoelectric conversion element 131b is set in the state ST52, the transistor 134b remains on, and the transistor 135 is turned off.

At this time, a photocurrent flows between the first current terminal and the second current terminal of the photoelectric conversion element 131b in accordance with the illuminance of light entering the photoelectric conversion element 131b. Further, the level of the gate voltage of the transistor 132b varies in accordance with the photocurrent. At this time, the value of the channel resistance between the source and the drain of the transistor 132b is changed.

Then, in a period T43 after input of the pulse of the light-detection control signal, the transistor 134b is turned off.

At that time, the gate voltage of the transistor 132b is kept at a value corresponding to the photocurrent of the photoelectric conversion element 131b in the period T42. Note that the period T43 is not necessarily provided; however, in the case where there is the period T43, the timing of outputting an optical data signal in the light-detection circuit can be set as appropriate. For example, the timing of outputting an optical data signal can be set as appropriate in a plurality of light-detection circuits.

Then, in a period T44, a pulse of the output selection signal is input.

At this time, the photoelectric conversion element 131b remains in the state ST52 and the transistor 133b is turned on.

When the transistor 133b is turned on, the light-detection circuit in FIG. 3B outputs an optical data signal from the rest of the other of the source and the drain of the transistor 132b or the other of the source and the drain of the transistor 133b. A current flowing through the source and drain of the transistor 132b and the source and drain of the transistor 133b depends on the level of the gate voltage of the transistor 132b. Therefore, optical data has a value corresponding to the illuminance of light entering the photoelectric conversion element 131b. The above is the example of the method for driving the light-detection circuit in FIG. 3B.

The light-detection circuits illustrated in FIGS. 3A to 3D each include a photoelectric conversion element, a light-detection control transistor, and an amplification transistor. The light-detection circuit generates optical data in accordance with a light-detection control signal and outputs the optical data as a data signal in accordance with an output selection signal. With the above configuration, optical data can be generated and output by the light-detection circuit.

### <Configuration Example of Display Circuit>

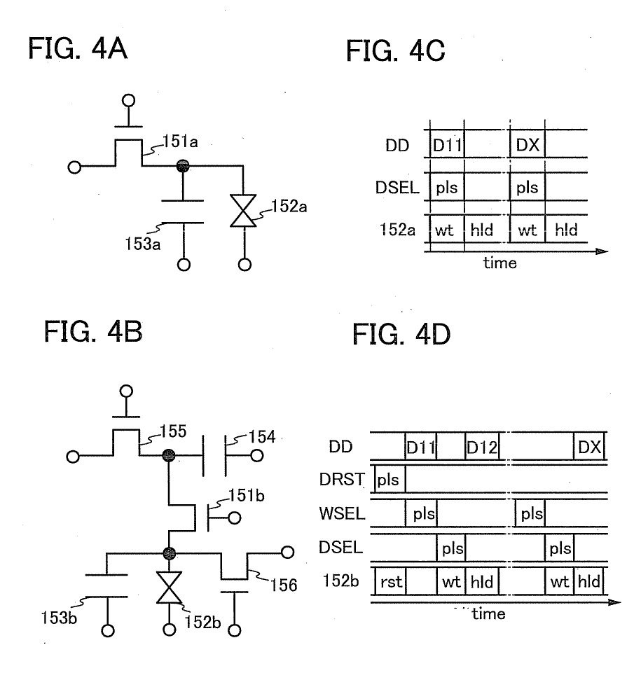

FIGS. 4A and 4B each illustrate a configuration example of the display circuit.

The display circuit illustrated in FIG. 4A includes a transistor 151a, a liquid crystal element 152a, and a capacitor 153a.

In the display circuit in FIG. 4A, the transistor 151 a is a field-effect transistor.

The liquid crystal element 152a includes a first display electrode, a second display electrode, and a liquid crystal layer. The light transmittance of the liquid crystal layer is changed in accordance with a voltage applied between the first display electrode and the second display electrode.

Further, the capacitor 153a includes a first capacitor electrode, a second capacitor electrode, and a dielectric layer overlapping with the first capacitor electrode and the second capacitor electrode. The capacitor 153a accumulates electric charge in accordance with a voltage applied between the first capacitor electrode and the second capacitor electrode.

A display data signal is input to one of a source and a drain of the transistor 151a. A display selection signal is input to a gate of the transistor 151a.

The first display electrode of the liquid crystal element 152a is electrically connected to the other of the source and the drain of the transistor 151a. A voltage Vc is input to the second display electrode of the liquid crystal element 152a. The level of the voltage Vc can be set as appropriate.

The first capacitor electrode of the capacitor 153a is electrically connected to the other of the source and the drain of the transistor 151a. The voltage Vc is input to the second capacitor electrode of the capacitor 153a.

The display circuit illustrated in FIG. 4B includes a transistor 151b, a liquid crystal element 152b, a capacitor 153b, a capacitor 154, a transistor 155, and a transistor 156.

In the display circuit in FIG. 4B, the transistors 151b, 155, and 156 are field-effect transistors.

A display data signal is input to one of a source and a drain of the transistor 155. A write selection signal (a signal WSEL) which is a pulse signal is input to a gate of the transistor 155. The write selection signal can be generated, for example, by output of a pulse signal from a shift register included in a circuit.

A first capacitor electrode of the capacitor 154 is electrically connected to the other of the source and the drain of the transistor 155. The voltage Vc is input to a second capacitor electrode of the capacitor 154.

One of a source and a drain of the transistor 151b is electrically connected to the other of the source and the drain of the transistor 155. A display selection signal is input to a gate of the transistor 151b.

A first display electrode of the liquid crystal element 152b is electrically connected to the other of the source and the drain of the transistor 151b. The voltage Vc is input to a second display electrode of the liquid crystal element 152b.

A first capacitor electrode of the capacitor 153b is electrically connected to the other of the source and the drain of the transistor 151b. The voltage Vc is input to a second capacitor electrode of the capacitor 153b. The level of the voltage Vc is set as appropriate in accordance with specifications of the display circuit.

A reference voltage is input to one of a source and a drain of the transistor 156. The other of the source and the drain of the transistor 156 is electrically connected to the other of the source and the drain of the transistor 151b. A display reset signal (a signal DRST) which is a pulse signal is input to a gate of the transistor 156.

Next, the components of the display circuits illustrated in FIGS. 4A and 4B will be described.

The transistors 151a and 151b each serve as a display selection transistor.

As a liquid crystal layer in each of the liquid crystal elements 152a and 152b, a liquid crystal layer that transmits light when a voltage applied between the first display electrode and the second display electrode is 0 V can be used. For example, it is possible to use a liquid crystal layer including electrically controlled birefringence liquid crystal (ECB liquid crystal), liquid crystal to which dichroic dye is added (GH liquid crystal), polymer-dispersed liquid crystal, or discotic liquid crystal. Alternatively, a liquid crystal layer exhibiting a blue phase may be used as the liquid crystal layer. The liquid crystal layer exhibiting a blue phase contains, for example, a liquid crystal composition including a liquid crystal exhibiting a blue phase and a chiral agent. The liquid crystal exhibiting a blue phase has a short response time of 1 msec or less and is optically isotropic; therefore, alignment treatment is not necessary and the viewing angle dependence is small. Thus, the operation speed can be increased with the liquid crystal exhibiting a blue phase.

The capacitors 153a and 153b each serve as a storage capacitor; a voltage corresponding to a display data signal is applied between the first capacitor electrode and the second capacitor electrode. The capacitors 153a and 153b are not necessarily provided; in the case where the capacitors 153a and 153b are provided, variations of voltage applied to the liquid crystal element due to leakage current of the display selection transistor can be suppressed.

The capacitor 154 serves as a storage capacitor; a voltage corresponding to a display data signal is applied between the first capacitor electrode and the second capacitor electrode.

The transistor 155 serves as a write selection transistor that selects whether a display data signal is input to the capacitor 154.

The transistor 156 serves as a display reset selection transistor that selects whether a voltage applied to the liquid crystal element 152b is reset.

Examples of the transistors 151a, 151b, 155, and 156 are a transistor including a semiconductor layer containing a semiconductor that belongs to Group 14 of the periodic table (e.g., silicon) and a transistor including an oxide semiconductor layer.

Next, examples of methods for driving the display circuits in FIGS. 4A and 4B will be described.

First, an example of a method for driving the display circuit in FIG. 4A will be described with reference to FIG. 4C. FIG. 4C is a timing chart for explaining the example of the method for driving the display circuit in FIG. 4A and shows the states of the display data signal and the display selection signal.

In the example of the method for driving the display circuit in FIG. 4A, the transistor 151a is turned on when a pulse of the display selection signal is input.

When the transistor 151a is turned on, the display data signal is input to the display circuit, so that the voltage of the first display electrode of the liquid crystal element 152a and the voltage of the first capacitor electrode of the capacitor 153a become equivalent to the voltage of the display data signal.

At this time, the liquid crystal element 152a is put in a write state (a state wt) and has a light transmittance corresponding to the display data signal, so that the display circuit is put in a display state corresponding to data (each of data D11 to data DX) of the display data signal.

After that, the transistor 151a is turned off. Thus, the liquid crystal element 152a is put in a hold state (a state hld) and keeps the voltage applied between the first display electrode and the second display electrode until the next pulse of the display selection signal is input.

Next, an example of a method for driving the display circuit in FIG. 4B will be described with reference to FIG. 4D. FIG. 4D is a timing chart for explaining the example of the method for driving the display circuit in FIG. 4B.

In the example of the method for driving the display circuit in FIG. 4B, when a pulse of the display reset signal is input, the transistor 156 is turned on, so that the voltage of the first display electrode of the liquid crystal element 152b and the voltage of the first capacitor electrode of the capacitor 153b are reset to the reference voltage.

Moreover, when a pulse of the write selection signal is input, the transistor 155 is turned on, whereby the display data signal is input to the display circuit, and the voltage of the first capacitor electrode of the capacitor 154 becomes equivalent to the voltage of the display data signal.

After that, when a pulse of the display selection signal is input, the transistor 151b is turned on, whereby the voltage of the first display electrode of the liquid crystal element 152b and the voltage of the first capacitor electrode of the capacitor 153b become equivalent to the voltage of the first capacitor electrode of the capacitor 154.

At this time, the liquid crystal element 152b is put in a write state and has a light transmittance corresponding to the display data signal, so that the display circuit is put in a display state corresponding to data (each of data D11 to data DX) of the display data signal.

After that, the transistor 151b is turned off. Thus, the liquid crystal element 152b is put in a hold state and keeps the voltage applied between the first display electrode and the second display electrode until the next pulse of the display selection signal is input.

The display circuits illustrated in FIGS. 4A and 4B each include a display selection transistor and a liquid crystal element. With the above configuration, the display circuit can be set in a display state corresponding to a display data signal.

The display circuit illustrated in FIG. 4B includes a write selection transistor and a capacitor in addition to the display selection transistor and the liquid crystal element. With the above configuration, while the liquid crystal element is set in a display state corresponding to data of a given display data signal, data of the next display data signal can be written into the capacitor. Consequently, the operation speed of the display circuit can be increased.

### <Structural Example of Display>

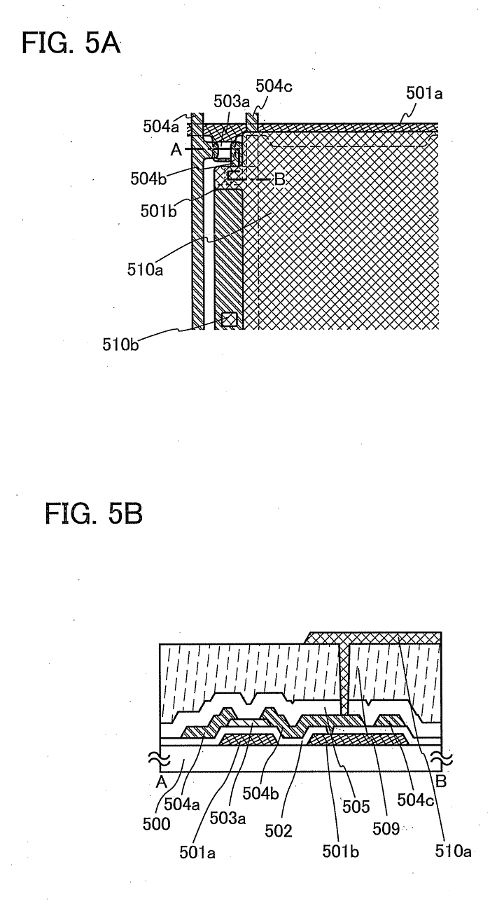

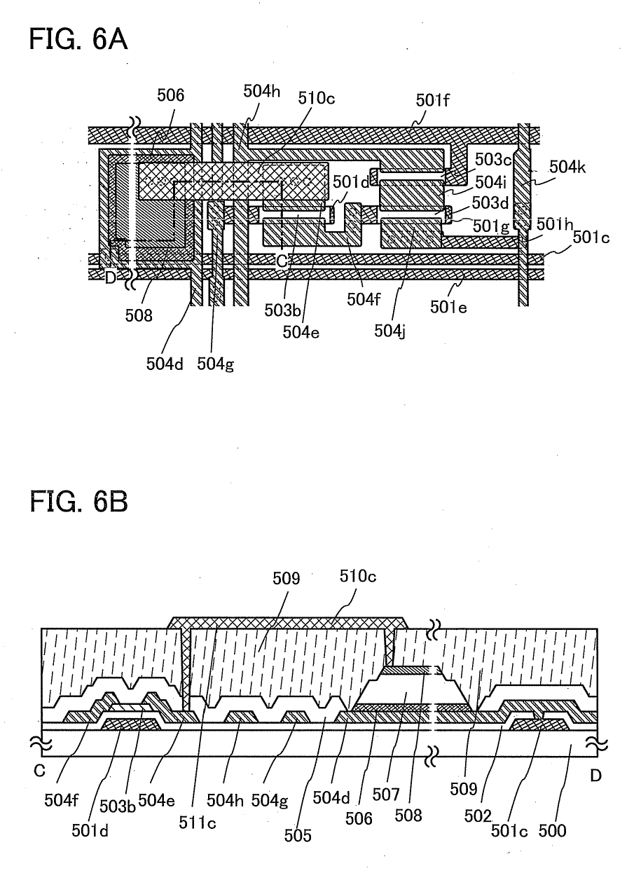

FIGS. 5A and 5B and FIGS. 6A and 6B illustrate a structural example of an active matrix substrate (a substrate provided with a display circuit and a light-detection circuit) included in a display. Specifically, FIG. 5A is a schematic plan view of a display circuit provided in the active matrix substrate; FIG. 5B is a schematic cross-sectional view taken along the line A-B in FIG. 5A; FIG. 6A is a schematic plan view of a light-detection circuit included in the active matrix substrate; and FIG. 6B is a schematic cross-sectional view taken along the line C-D in FIG. 6A. Note that FIGS. 6A and 6B illustrate a light-detection circuit having the configuration in FIG. 3A, as an example.

The active matrix substrate illustrated in FIGS. 5A and 5B and FIGS. 6A and 6B includes a substrate 500, conductive layers 501a to 501h, an insulating layer 502, semiconductor layers 503a to 503d, conductive layers 504a to 504k, an insulating layer 505, a semiconductor layer 506, a semiconductor layer 507, a semiconductor layer 508, an insulating layer 509, and conductive layers 510a to 510c.

Each of the conductive layers 501a to 501h is formed over one surface of the substrate 500.

The conductive layer 501a functions as a gate of a display selection transistor in the display circuit.

The conductive layer 501b functions as a first capacitor electrode of a storage capacitor in the display circuit. Note that the layer serving as a first capacitor electrode of a capacitor (a storage capacitor) is also referred to as a first capacitor electrode.

The conductive layer 501c functions as a wiring to which the voltage Vb is input. Note that a layer having a function of a wiring can be referred to as a wiring.

The conductive layer 501d functions as a gate of a light-detection control transistor in the light-detection circuit.

The conductive layer 501e functions as a signal line to which the light-detection control signal is input. Note that a layer having a function of a signal line can be referred to as a signal line.

The conductive layer 501f functions as a gate of an output selection transistor in the light-detection circuit.

The conductive layer 501g functions as a gate of an amplification transistor in the light-detection circuit.

The insulating layer 502 is provided over the one surface of the substrate 500 with the conductive layers 501a to 501h placed therebetween.

The insulating layer 502 functions as a gate insulating layer of the display selection transistor in the display circuit, a dielectric layer of the storage capacitor in the display circuit, a gate insulating layer of the light-detection control transistor in the light-detection circuit, a gate insulating layer of the amplification transistor in the light-detection circuit, and a gate insulating layer of the output selection transistor in the light-detection circuit.

The semiconductor layer 503a overlaps with the conductive layer 501a with the insulating layer 502 placed therebetween. The semiconductor layer 503a functions as a channel formation layer of the display selection transistor in the display circuit.

The semiconductor layer 503b overlaps with the conductive layer 501d with the insulating layer 502 placed therebetween. The semiconductor layer 503b functions as a channel formation layer of the light-detection control transistor in the light-detection circuit.

The semiconductor layer 503c overlaps with the conductive layer 501f with the insulating layer 502 placed therebetween. The semiconductor layer 503c functions as a channel formation layer of the output selection transistor in the light-detection circuit.

The semiconductor layer 503d overlaps with the conductive layer 501g with the insulating layer 502 placed therebetween. The semiconductor layer 503d functions as a channel formation layer of the amplification transistor in the light-detection circuit.

The conductive layer 504a is electrically connected to the semiconductor layer 503a. The conductive layer 504a functions as one of a source and a drain of the display selection transistor in the display circuit.

The conductive layer 504b is electrically connected to the conductive layer 501b and the semiconductor layer 503a. The conductive layer 504b functions as the other of the source and the drain of the display selection transistor in the display circuit.

The conductive layer 504c overlaps with the conductive layer 501b with the insulating layer 502 placed therebetween. The conductive layer 504c functions as a second capacitor electrode of the storage capacitor in the display circuit.

The conductive layer 504d is electrically connected to the conductive layer 501c through an opening portion that penetrates the insulating layer 502. The conductive layer 504d functions as one of a first current terminal and a second current terminal of a photoelectric conversion element in the light-detection circuit.

The conductive layer 504e is electrically connected to the semiconductor layer 503b. The conductive layer 504e functions as one of a source and a drain of the light-detection control transistor in the light-detection circuit.

The conductive layer 504f is electrically connected to the semiconductor layer 503b and is electrically connected to the conductive layer 501g through an opening portion that penetrates the insulating layer 502. The conductive layer 504f functions as the other of the source and the drain of the light-detection control transistor in the light-detection circuit.

The conductive layer 504g is electrically connected to the conductive layers 501d and 501e through opening portions that penetrate the insulating layer 502. The conductive layer 504g functions as a signal line to which the light-detection control signal is input.

The conductive layer 504h is electrically connected to the semiconductor layer 503c. The conductive layer 504h functions as one of a source and a drain of the output selection transistor in the light-detection circuit.

The conductive layer 504i is electrically connected to the semiconductor layers 503c and 503d. The conductive layer 504i functions as the other of the source and the drain of the output selection transistor in the light-detection circuit and one of a source and a drain of the amplification transistor in the light-detection circuit.

The conductive layer 504j is electrically connected to the semiconductor layer 503d and is electrically connected to the conductive layer 501h through an opening portion that penetrates the insulating layer 502. The conductive layer 504j functions as the other of the source and the drain of the amplification transistor in the light-detection circuit.

The conductive layer 504k is electrically connected to the conductive layer 501h through an opening portion that penetrates the insulating layer 502. The conductive layer 504k functions as a wiring to which the voltage Va or the voltage Vb is input.

The insulating layer 505 is in contact with the semiconductor layers 503a to 503d with the conductive layers 504a to 504k placed therebetween.

The semiconductor layer 506 is electrically connected to the conductive layer 504d through an opening portion that penetrates the insulating layer 505.

The semiconductor layer 507 is in contact with the semiconductor layer 506.

The semiconductor layer 508 is in contact with the semiconductor layer 507.

The insulating layer 509 overlaps with the insulating layer 505, the semiconductor layer 506, the semiconductor layer 507, and the semiconductor layer 508. The insulating layer 509 functions as a planarization insulating layer in the display circuit and the light-detection circuit. Note that the insulating layer 509 is not necessarily provided.

The conductive layer 510a is electrically connected to the conductive layer 504b through an opening portion that penetrates the insulating layers 505 and 509. The conductive layer 510a functions as a pixel electrode of a display element in the display circuit. Note that a layer having a function of a pixel electrode can be referred to as a pixel electrode.

The conductive layer 510b is electrically connected to the conductive layer 504c through an opening portion that penetrates the insulating layers 505 and 509. The conductive layer 510b functions as a wiring to which the voltage Vc is input.

The conductive layer 510c is electrically connected to the conductive layer 504e through an opening portion that penetrates the insulating layers 505 and 509, and is electrically connected to the semiconductor layer 508 through an opening portion that penetrates the insulating layers 505 and 509.

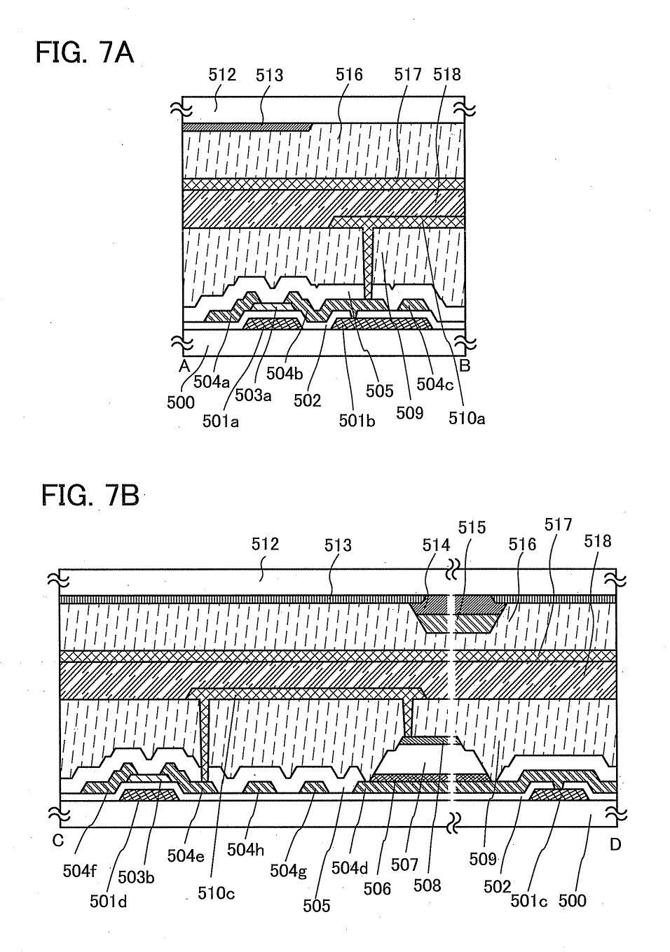

Further, a structural example of a display including the above-described active matrix substrate will be described with reference to FIGS. 7A and 7B. Note that FIG. 7A is a schematic cross-sectional view of a display circuit provided in the display, and FIG. 7B is a schematic cross-sectional view of the light-detection circuit provided in the display. In the display illustrated in FIGS. 7A and 7B, the display element is a liquid crystal element.

The display illustrated in FIGS. 7A and 7B includes a substrate 512, a light-blocking layer 513, a coloring layer 514, a coloring layer 515, an insulating layer 516, a conductive layer 517, and a liquid crystal layer 518 in addition to the active matrix substrate illustrated in FIGS. 5A and 5B and FIGS. 6A and 6B.

The light-blocking layer 513 is provided on part of one surface of the substrate 512.

The coloring layer 514 is provided on part of the substrate 512 where the light-blocking layer 513 is not provided, and overlaps with the semiconductor layer 506, the semiconductor layer 507, and the semiconductor layer 508.

The coloring layer 515 overlaps with the coloring layer 514.

The insulating layer 516 is provided on the one surface of the substrate 512 with the light-blocking layer 513, the coloring layer 514, and the coloring layer 515 placed therebetween.

The conductive layer 517 is provided on the one surface of the substrate 512. The conductive layer 517 functions as a common electrode in the display circuit. Note that the conductive layer 517 is not necessarily provided in the light-detection circuit.

The liquid crystal layer 518 is provided between the conductive layer 510a and the conductive layer 517 and overlaps with the semiconductor layer 508 with the insulating layer 509 placed therebetween.

The conductive layer 510a, the liquid crystal layer 518, and the conductive layer 517 function as the display element in the display circuit.

Further, the components of the display illustrated in FIGS. 7A and 7B will be described.

Each of the substrates 500 and 512 can be a light-transmitting substrate such as a glass substrate or a plastic substrate.

As the conductive layers 501a to 501d, it is possible to use, for example, a layer of a metal material such as molybdenum, titanium, chromium, tantalum, tungsten, aluminum, copper, neodymium, or scandium or an alloy material containing any of these materials as a main component. The conductive layers 501a to 501d can also be formed by stacking these layers.

The insulating layers 502 and 505 can be, for example, a silicon oxide layer, a silicon nitride layer, a silicon oxynitride layer, a silicon nitride oxide layer, an aluminum oxide layer, an aluminum nitride layer, an aluminum oxynitride layer, an aluminum nitride oxide layer, or a hafnium oxide layer. Alternatively, the insulating layers 502 and 505 can be formed by stacking these layers.

Alternatively, a semiconductor layer containing a semiconductor belonging to Group 14 of the periodic table (e.g., silicon) or an oxide semiconductor layer may be used as the semiconductor layers 503a and 503b.

As the conductive layers 504a to 504h, it is possible to use, for example, a layer of a metal material such as aluminum, chromium, copper, tantalum, titanium, molybdenum, or tungsten, or an alloy material containing any of these metal materials as a main component. Alternatively, the conductive layers 504a to 504h can be formed by stacking these layers.

The semiconductor layer 506 is a semiconductor layer of one conductivity type (i.e., one of a p-type semiconductor layer or an n-type semiconductor layer). As the semiconductor layer 506, a semiconductor layer containing silicon can be used, for example.

The semiconductor layer 507 has a resistance higher than that of the semiconductor layer 506. As the semiconductor layer 507, a semiconductor layer containing silicon can be used, for example.

The semiconductor layer 508 is a semiconductor layer whose conductivity type is different from that of the semiconductor layer 506 (i.e., the other of the p-type semiconductor layer and the n-type semiconductor layer). As the semiconductor layer 508, a semiconductor layer containing silicon can be used, for example.

As the insulating layer 509 and the insulating layer 516, a layer of an organic material such as polyimide, acrylic, or benzocyclobutene can be used, for example. Alternatively, as the insulating layer 509, a layer of a low-dielectric constant material (also referred to as a low-k material) can be used.

As the conductive layers 510a and 510c and the conductive layer 517, for example, it is possible to use a layer of a light-transmitting conductive material such as indium tin oxide, a metal oxide in which zinc oxide is mixed in indium oxide, a conductive material in which silicon oxide (SiO₂) is mixed in indium oxide, organoindium, organotin, indium oxide containing tungsten oxide, indium zinc oxide containing tungsten oxide, indium oxide containing titanium oxide, or indium tin oxide containing titanium oxide.

Alternatively, the conductive layers 510a and 510c and the conductive layer 517 can be formed using a conductive composition containing a conductive high molecule (also referred to as a conductive polymer). A conductive layer formed using the conductive composition preferably has a sheet resistance of 10000 ohms per square or less and a light transmittance of 70% or more at a wavelength of 550 nm. Furthermore, the resistivity of the conductive high molecule contained in the conductive composition is preferably less than or equal to 0.1 Ω·cm.

As the conductive high molecule, a so-called π-electron conjugated conductive high molecule can be used. For example, polyaniline or a derivative thereof, polypyrrole or a derivative thereof, polythiophene or a derivative thereof, a copolymer of two or more of aniline, pyrrole, and thiophene or a derivative thereof can be given as the π-electron conjugated conductive high molecule.

As the light-blocking layer 513, a layer of a metal material can be used, for example.

The coloring layer 514 is one of a red coloring layer and a blue coloring layer.

The coloring layer 515 is the other of the red coloring layer and the blue coloring layer.

Note that the stack of the coloring layer 514 and the coloring layer 515 functions as a filter for absorbing light with a wavelength in the visible light region.

As the liquid crystal layer 518, a layer including TN liquid crystal, OCB liquid crystal, STN liquid crystal, VA liquid crystal, ECB liquid crystal, GH liquid crystal, polymer dispersed liquid crystal, or discotic liquid crystal can be used, for example. Note that for the liquid crystal layer 518, it is preferable to use liquid crystal that transmits light when a voltage applied between the conductive layers 510c and 517 is 0 V.

As described with FIGS. 5A and 5B, FIGS. 6A and 6B, and FIGS. 7A and 7B, the display includes an active matrix substrate provided with a transistor, a pixel electrode, and a photoelectric conversion element; a counter substrate; and a liquid crystal layer including liquid crystal, placed between the active matrix substrate and the counter substrate. With the above structure, the display circuit and the light-detection circuit can be formed over one substrate through one process; thus, manufacturing costs can be reduced.

As described with reference to FIGS. 7A and 7B, the display includes the filter that overlaps with the photoelectric conversion element and absorbs light with a wavelength in the visible light region. With the above structure, light with a wavelength in the visible light region (e.g., light with a wavelength in the visible light region emitted from a light-emitting diode) can be prevented from entering the photoelectric conversion element, so that accuracy of detection of light in an infrared light region can be improved.

### <Modified Structural Example of Light-Detection Circuit>

The structure of the light-detection circuit disclosed in this specification is not limited to the structure illustrated in FIGS. 6A and 6B. For example, although FIGS. 6A and 6B illustrate the photoelectric conversion element having a structure where semiconductor layers of different conductivity types are stacked (such a structure is also referred to as a vertical structure), a photoelectric conversion element having a structure where one semiconductor layer is provided with regions of different conductivity types (such a structure is also referred to as a horizontal structure) can also be employed as the photoelectric conversion element of the light-detection circuit.

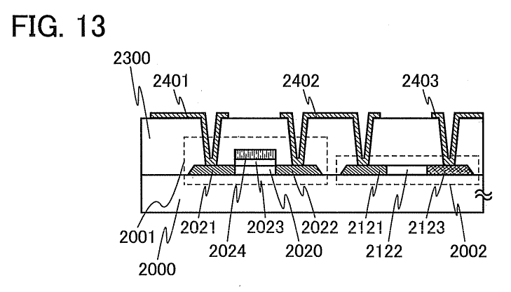

FIG. 13 illustrates a structural example of a light-detection circuit including a photoelectric conversion element having a horizontal structure. Specifically, FIG. 13 illustrates an example of a transistor (transistor 2001) included in the light-detection circuit and an example of a photoelectric conversion element (photoelectric conversion element 2002) electrically connected to the transistor.

The transistor 2001 includes impurity regions 2021 and 2022 and a channel formation region 2020 that are formed using single crystal silicon provided over a substrate 2000 having an insulating surface, a gate insulating layer 2023 provided over the channel formation region 2020, and a gate layer 2024 provided over the gate insulating layer 2023. Note that the example where the transistors 2001 is formed using single crystal silicon is shown here; alternatively, the transistor can be formed using polycrystalline silicon or amorphous silicon.

The photoelectric conversion element 2002 includes a p-type impurity region 2121, an i-type region 2122, and an n-type impurity region 2123 that are formed using single crystal silicon provided over the substrate 2000 having an insulating surface.

Note that an insulating layer 2300 is provided over the transistor 2001 and the photoelectric conversion element 2002. The impurity region 2021 of the transistor 2001 is connected to a conductive layer 2401. The impurity region 2022 of the transistor 2001 and the p-type impurity region 2121 of the photoelectric conversion element 2002 are connected to each other through a conductive layer 2402. A conductive layer 2403 is connected to the n-type impurity region 2123 of the photoelectric conversion element 2002.

### <Configuration Example of Capacitive Touch Sensor>

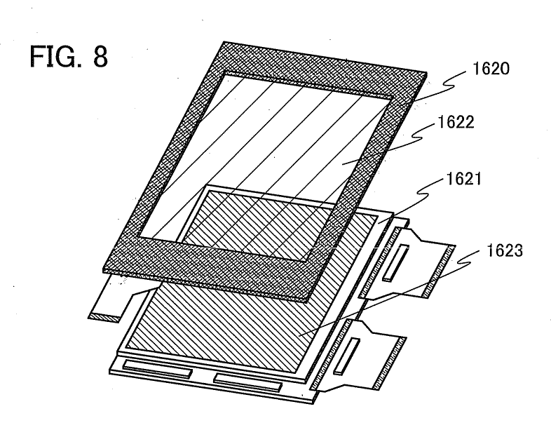

A display device according to one embodiment of the present invention includes a capacitive touch sensor. FIG. 8 shows that a capacitive touch sensor 620 and a display 1621 overlap with each other.

In the capacitive touch sensor 1620, a position touched by a finger, a stylus, or the like is detected in a light-transmitting position detection portion 1622 and a signal including information on the position can be generated. Thus, by providing the touch sensor 1620 so that the position detection portion 1622 overlaps with a pixel portion 1623 of the display 1621, information on a position in the pixel portion 1623 the user of the display device touches can be obtained.

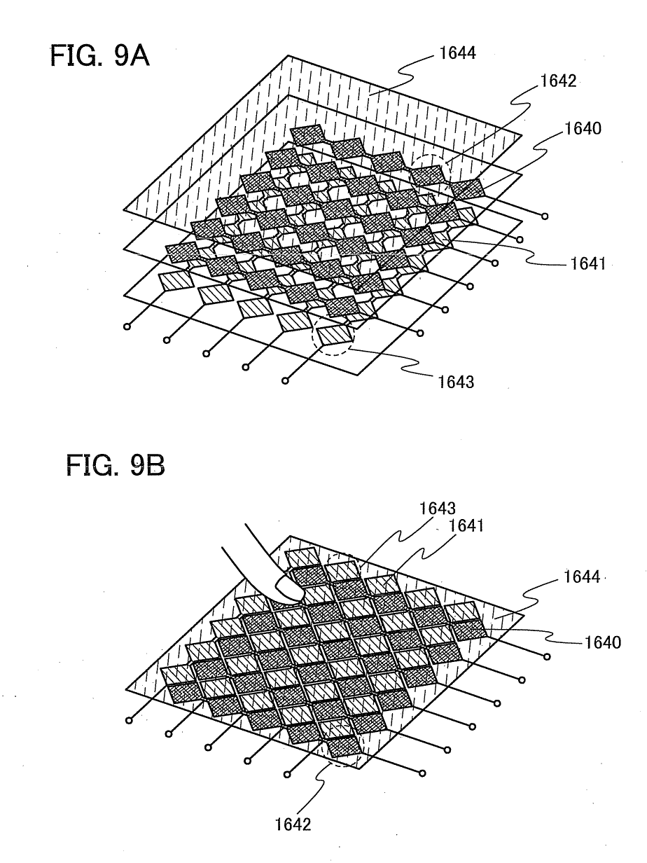

FIG. 9A is a perspective view of the position detection portion 1622 with a projected capacitive touch technology among capacitive touch technologies. In the position detection portion 1622 with the projected capacitive touch technology, a plurality of first electrodes 1640 and a plurality of second electrodes 1641 are provided so as to overlap with each other. The first electrodes 1640 each have a structure in which a plurality of rectangular conductive films 1642 is connected to each other. The second electrodes 1641 each have a structure in which a plurality of rectangular conductive films 1643 is connected to each other. Note that the shapes of the first electrodes 1640 and the second electrodes 1641 are not limited thereto.

In FIG. 9A, an insulating layer 1644 functioning as a dielectric overlaps with the plurality of first electrodes 1640 and the plurality of second electrodes 1641. FIG. 9B shows that the plurality of first electrodes 1640, the plurality of second electrodes 1641, and the insulating layer 1644 illustrated in FIG. 9A overlap with each other. As illustrated in FIG. 9B, the plurality of first electrodes 1640 and the plurality of second electrodes 1641 overlap with each other so that the position of the rectangular conductive films 1642 does not correspond to that of the rectangular conductive films 1643.

When a finger or the like touches the insulating layer 1644, capacitance is generated between one of the plurality of first electrodes 1640 and the finger. Moreover, capacitance is also generated between one of the plurality of second electrodes 1641 and the finger. Accordingly, monitoring of the change in capacitance can specify which first electrode 1640 and which second electrode 1641 are closest to the finger; thus, the position touched by the finger can be detected.

Note that the first electrodes 1640 and the second electrodes 1641 can be formed using a light-transmitting conductive material such as indium tin oxide containing silicon oxide, indium tin oxide, zinc oxide, indium zinc oxide, or zinc oxide to which gallium is added.

### <Operation Example of Display Device>

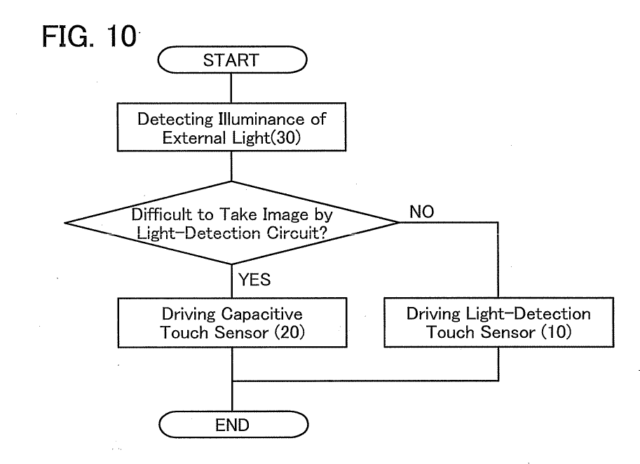

FIG. 10 is a flow chart showing an operation example of the display device illustrated in FIG. 1A. Specifically, the flow chart in FIG. 10 shows an example of an object detection operation of the display device illustrated in FIG. 1A.

In the flow chart in FIG. 10, first, the illuminance sensor 30 illustrated in FIG. 1A detects the illuminance of external light. Next, the information about the detected illuminance is used to choose between driving the light-detection touch sensor (light-detection circuit) provided in the display 10 illustrated in FIG. 1A and driving the capacitive touch sensor 20 illustrated in FIG. 1A. In other words, an appropriate touch sensor is chosen from the two kinds of touch sensors. Then, the touch sensor selected detects an object.

By the operation illustrated in FIG. 10, the object detection accuracy can be prevented from decreasing due to the influence of external light.

### EXAMPLE 1

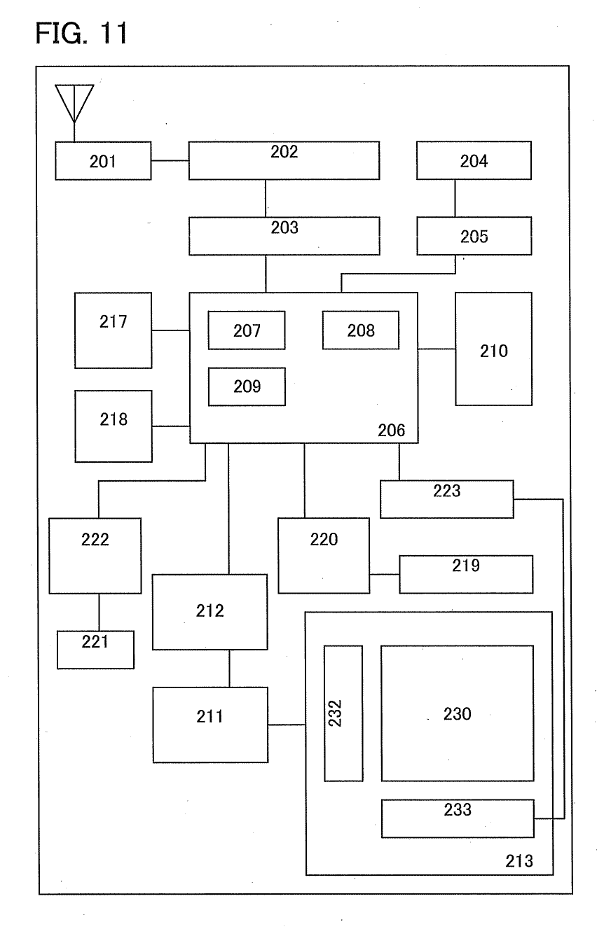

In this example, a configuration example of an electronic device including a display device according to one embodiment of the present invention will be described with reference to FIG. 11.

Examples of the electronic device include personal computers, mobile phones, game machines including portable game machines, portable information terminals, electronic books, video cameras, digital still cameras, navigation systems, audio reproducing devices (e.g., car audio systems and digital audio players), copiers, facsimiles, printers, multifunction printers, automated teller machines (ATM), vending machines, and the like.

FIG. 11 illustrates a configuration example of a mobile phone (including a so-called smartphone) having a display device according to one embodiment of the present invention. The portable electronic device illustrated in FIG. 11 includes an RF circuit 201, an analog baseband circuit 202, a digital baseband circuit 203, a battery 204, a power supply circuit 205, an application processor 206, a flash memory 210, a display circuit controller 211, a memory circuit 212, a display 213, an audio circuit 217, a keyboard 218, a capacitive touch sensor 219, a capacitive touch sensor controller 220, an illuminance sensor 221, an illuminance sensor controller 222, a light-detection circuit controller 223, and the like. The display 213 includes a pixel portion 230 provided with a display circuit and a light-detection circuit, a display circuit driver 232 (note that the display selection signal output circuit 101 and the display data signal output circuit 102 illustrated in FIG. 2 are included in the display circuit driver 232), a light-detection circuit driver 233 (note that the light-detection reset signal output circuit 103a, the light-detection control signal output circuit 103b, the output selection signal output circuit 103c, and the read circuit 106 illustrated in FIG. 2 are included in the light-detection circuit driver 233), and the like. Note that the application processor 206 includes a CPU 207, a DSP 208, an interface (IF) 209, and the like.

### EXAMPLE 2

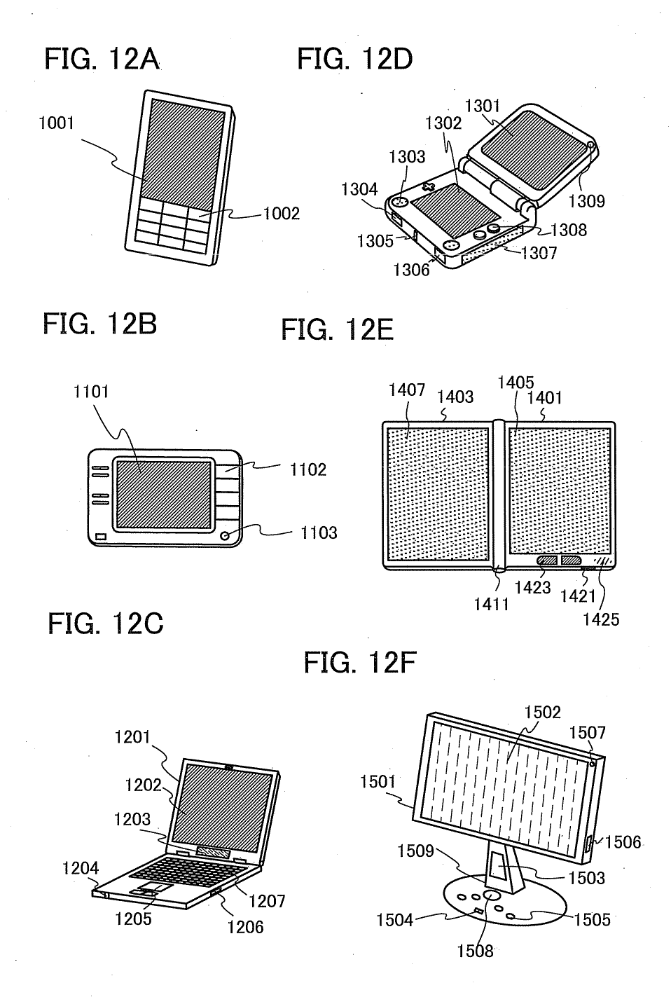

In this example, specific examples of electronic devices each including a display device according to one embodiment of the present invention will be described with reference to FIGS. 12A to 12F.

FIG. 12A illustrates a specific example of a portable information communication terminal. The portable information communication terminal in FIG. 12A includes at least a display portion 1001. In the portable information communication terminal in FIG. 12A, for example, the display portion 1001 can be provided with an operation portion 1002. By using the above-described display device for the display portion 1001, operation of the portable information communication terminal or input of data to the portable information communication terminal can be performed with a finger or a pen, for example.

FIG. 12B illustrates a specific example of an information guide terminal including an automotive navigation system. The information guide terminal in FIG. 12B includes a display portion 1101, operation buttons 1102, and an external input terminal 1103. By using the above-described display device for the display portion 1101, operation of the information guide terminal or input of data to the information guide terminal can be performed with a finger or a pen, for example.

FIG. 12C illustrates a specific example of a notebook personal computer. The notebook personal computer in FIG. 12C includes a housing 1201, a display portion 1202, a speaker 1203, an LED lamp 1204, a pointing device 1205, a connection terminal 1206, and a keyboard 1207. By using the above-described display device for the display portion 1202, operation of the notebook personal computer or input of data to the notebook personal computer can be performed with a finger or a pen, for example.

FIG. 12D illustrates a specific example of a portable game machine. The portable game machine in FIG. 12D includes a display portion 1301, a display portion 1302, a speaker 1303, a connection terminal 1304, an LED lamp 1305, a microphone 1306, a recording medium read portion 1307, operation buttons 1308, and a sensor 1309. By using the above-described display device for the display portion 1301 and/or the display portion 1302, operation of the portable game machine or input of data to the portable game machine can be performed with a finger or a pen, for example.

FIG. 12E illustrates a specific example of an electronic book. The electronic book in FIG. 12E includes at least a housing 1401, a housing 1403, a display portion 1405, a display portion 1407, and a hinge 1411.

The housing 1401 and the housing 1403 are connected to each other with the hinge 1411 so that the electronic book in FIG. 12E can be opened and closed with the hinge 1411 as an axis. With such a structure, the electronic book can be handled like a paper book. The display portion 1405 and the display portion 1407 are incorporated in the housing 1401 and the housing 1403, respectively. The display portion 1405 and the display portion 1407 may be configured to display different images. For example, one image can be displayed across both the display portions. In the case where different images are displayed on the display portion 1405 and the display portion 1407, for example, text can be displayed on the display portion on the right side (the display portion 1405 in FIG. 12E) and graphics can be displayed on the display portion on the left side (the display portion 1407 in FIG. 12E).

In the electronic book in FIG. 12E, the housing 1401 or the housing 1403 may be provided with an operation portion or the like. For example, the electronic book in FIG. 12E may include a power button 1421, operation keys 1423, and a speaker 1425. In the electronic book in FIG. 12E, pages of an image can be turned with the operation keys 1423. Furthermore, the display portion 1405 and/or the display portion 1407 of the electronic book illustrated in FIG. 12E may be provided with a keyboard, a pointing device, or the like. Moreover, an external connection terminal (e.g., an earphone terminal, a USB terminal, or a terminal connectable to an AC adapter or a variety of cables such as a USB cable), a recording medium insertion portion, and the like may be provided on a back surface or a side surface of the housing 1401 and the housing 1403 of the electronic book in FIG. 12E. In addition, a function of an electronic dictionary may be added to the electronic book in FIG. 12E.

By using the above-described display device for the display portion 1405 and/or the display portion 1407, operation of the electronic book or input of data to the electronic book can be performed with a finger or a pen, for example.

An electronic device illustrated in FIG. 12F is a display. The display in FIG. 12F includes a housing 1501, a display portion 1502, a speaker 1503, an LED lamp 1504, operation buttons 1505, a connection terminal 1506, a sensor 1507, a microphone 1508, and a supporting base 1509. By using the above-described display device for the display portion 1502, operation of the display or input of data to the display can be performed with a forger or a pen, for example.

This application is based on Japanese Patent Application serial no. 2011-152067 filed with Japan Patent Office on Jul. 8, 2011, the entire contents of which are hereby incorporated by reference.

What is claimed is:

1. A display device comprising:
a display including a light-detection sensor;
a capacitive touch sensor overlapping with the display;
an illuminance sensor configured to detect an illuminance of external light; and
a control unit configured to choose between driving the light-detection sensor and driving the capacitive touch sensor on a basis of an output value of the illuminance sensor.

2. The display device according to claim 1, wherein the light-detection sensor is provided in a pixel portion.

3. The display device according to claim 1, wherein the display is configured to display an image by control of orientation of a liquid crystal.

4. The display device according to claim 1, wherein the light-detection sensor is configured to detect light with a wavelength in an infrared light region.

5. The display device according to claim 1, further comprising a filter overlapping with the light-detection sensor, the filter capable of absorbing light with a wavelength in a visible light region.

6. The display device according to claim 1, wherein the light-detection sensor is used as a light-detection touch sensor.

7. A display device comprising:
a display including a light-detection sensor, the display comprising:
a transistor over a first substrate;
a photoelectric conversion element over the first substrate; and
a liquid crystal layer between the first substrate and a second substrate;
a capacitive touch sensor overlapping with the display;
an illuminance sensor configured to detect an illuminance of external light; and
a control unit configured to choose between driving the light-detection sensor and driving the capacitive touch sensor on a basis of an output value of the illuminance sensor.

8. The display device according to claim 7, wherein the display is configured to display an image by control of orientation of a liquid crystal.

9. The display device according to claim 7, wherein the light-detection sensor is configured to detect light with a wavelength in an infrared light region.

10. The display device according to claim 7, further comprising a filter overlapping with the light-detection sensor, the filter capable of absorbing light with a wavelength in a visible light region.

11. The display device according to claim 7, wherein the light-detection sensor is used as a light-detection touch sensor.

12. A display device comprising:
a display including a light-detection sensor,
wherein the display comprises:
a first transistor over a first substrate;
a capacitor over the first substrate; and
a liquid crystal layer between the first substrate and a second substrate, and
wherein the light-detection sensor comprises:
a second transistor over the second substrate; and
a photoelectric conversion element over the first substrate;
a capacitive touch sensor overlapping with the display;
an illuminance sensor configured to detect an illuminance of external light; and
a control unit configured to choose between driving the light-detection sensor and driving the capacitive touch sensor on a basis of an output value of the illuminance sensor.

13. The display device according to claim 12, wherein the display is configured to display an image by control of orientation of a liquid crystal.

14. The display device according to claim 12, wherein the light-detection sensor is configured to detect light with a wavelength in an infrared light region.

15. The display device according to claim 12, further comprising a filter overlapping with the light-detection sensor, the filter capable of absorbing light with a wavelength in a visible light region.

16. The display device according to claim 12, wherein the light-detection sensor is used as a light-detection touch sensor.
